(19) United States
(12) Patent Application Publication
(10) Pub. No.: US 2008/0280031 A1
(43) Pub. Date: Nov. 13, 2008

(54) Conductive coatings produced by monolayer deposition on surfaces

(75) Inventors: Lawrence T. Drzal, Okemos, MI (US); InHwan Do, Lansing, MI (US)

Correspondence Address: Ian C. McLeod;IAN C. MCLEOD, P.C., 2190 Commons Parkway, Okemos, MI, 48864, US

(73) Assignee: Board of Trustees of Michigan State University, East Lansing, MI (US)

(21) Appl. No.: 11/801,261

(22) Filed: May 9, 2007

Related U.S. Application Data
(60) Provisional application No. 60/800,604, filed on May 16, 2006.

(51) Int. Cl. B05D 5/12; H01B 1/24; B06B 1/00; B29C 71/04

(52) U.S. Cl. 427/78; 252/511; 427/77; 427/600; 427/532

(57) ABSTRACT

Low resistivity graphite coated fibers having exfoliated and pulverized graphite platelets coated on an outer surface of electrically insulating fibers are provided. Various methods are also provided for surface coating of the graphite platelets onto the insulating fibers which are provided to increase the glass fiber surface conductivity. The graphite coated glass fibers can be used to produce reinforced composite materials. Reinforced composite materials incorporating the graphite coated fibers can be electrostatically painted without using a conductive primer.

### CROSS-REFERENCE TO RELATED APPLICATION

This application claims benefit to U.S. Provisional Application Ser. No. 60/800,604, filed May 16, 2006, which is incorporated herein by reference in its entirety.

### STATEMENT REGARDING FEDERALLY SPONSORED RESEARCH OR DEVELOPMENT

Not applicable.

### BACKGROUND OF THE INVENTION

(1) Field of the Invention

The present invention relates to nanocomposite materials. More specifically, the present invention relates to fiber reinforcements coated with exfoliated graphite that are incorporated into the polymer matrix of nanocomposite materials. The exfoliated graphite coating improves the electrical properties of the resulting nanocomposite materials.

(2) Description of Related Art

Nanocomposites composed of polymer matrices with reinforcements of less than 100 nm in size, are being considered for applications such as interior and exterior accessories for automobiles, structural components for portable electronic devices, and films for food packaging (Giannelis, E. P., Appl. Organometallic Chem., Vol. 12, pp. 675 (1998); and Pinnavala, T. J. et al., Polymer Clay Nanocomposites. John Wiley & Sons, Chichester, England (2000)). While most nanocomposite research has focused on exfoliated clay platelets, the same nanoreinforcement concept can be applied to another layered material, graphite, to produce nanoplatelets and nanocomposites (Pan, Y. X., et al., J. Polym. Sci., Part B: Polym. Phy., Vol. 38, pp. 1626 (2000); and Chen, G. H., et al., J. Appl. Polym. Sci. Vol. 82, pp. 2506 (2001)). Graphite is the stiffest material found in nature (Young's Modulus=1060 MPa), having a modulus several times that of clay, but also with excellent electrical and thermal conductivity. With the appropriate surface treatment, exfoliation and dispersion in a thermoset or thermoplastic polymer matrix results in a composite with excellent mechanical, electrical and thermal properties, opening up many new structural applications as well as non-structural ones where electromagnetic shielding and high thermal conductivity are requirements as well. Furthermore, the economics of producing nanographite platelets indicate a cost of $5 per pound appear to be attainable.

Graphite is a well known material occurring in natural and synthetic form and is well described in the literature. Illustrative of this art is a monograph by Michel A. Boucher, Canadian Minerals Yearbook 24.1-24.9 (1994). A useful form of graphite is expanded graphite which has been known for years. The first patents related to this topic appeared as early as 1910 (U.S. Pat. Nos. 1,137,373 and 1,191,383). Since then, numerous patents related to the methods and resulting expanded graphites have been issued. For example, many patents have been issued related to the expansion process (U.S. Pat. Nos. 4,915,925 and 6,149,972), expanded graphite-polymer composites (U.S. Pat. Nos. 4,530,949, 4,704,231, 4,946,892, 5,582,781, 4,091,083 and 5,846,459), flexible graphite sheet and its fabrication process by compressing expanded graphite (U.S. Pat. Nos. 3,404,061, 4,244,934, 4,888,242, 4,961,988, 5,149,518, 5,294,300, 5,582,811, 5,981,072 and 6,143,218), and flexible graphite sheet for fuel cell elements (U.S. Pat. Nos. 5,885,728 and 6,060,189). Also there are patents relating to grinding/pulverization methods for expanded graphite to produce fine graphite flakes (U.S. Pat. Nos. 6,287,694, 5,330,680 and 5,186,919). All of these patents use a heat treatment, typically in the range of 600° C. to 1200° C., as the expansion method for graphite. The heating by direct application of heat generally requires a significant amount of energy, especially in the case of large-scale production. Radiofrequency (RF) or microwave expansion methods can heat more material in less time at lower cost. U.S. Pat. No. 6,306,264 to Kwon et al. discusses microwave as one of the expansion methods for SO₃ intercalated graphite in solution.

U.S. Pat. Nos. 5,019,446 and 4,987,175 describe graphite flake reinforced polymer composites and the fabrication method. These patents did not specify the methods to produce thin, small graphite flakes. The thickness (less than 100 nm) and aspect ratio (more than 100) of the graphite reinforcement was described.

Many patents have been issued related to anode materials for lithium-ion or lithium-polymer batteries (U.S. Pat. Nos. 5,344,726, 5,522,127, 5,591,547, 5,672,446, 5,756,062, and 6,136,474). Among these materials, one of the most widely investigated and used is graphite flakes with appropriate size, typically 2 to 50 μm, with less oxygen-containing functional groups at the edges. Most of the patents described graphite flakes made by carbonization of precursor material, such as petroleum coke or coal-tar pitch, followed by graphitization process.

U.S. Pat. Nos. 4,777,336 to Asmussen et al., 5,008,506 to Asmussen, 5,770,143 to Hawley et al., and 5,884,217 to Hawley et al. describe various microwave or radiofrequency wave systems for heating a material. These applications and patents are hereby incorporated herein by reference in their entirety.

### SUMMARY OF THE INVENTION

The expanded graphite is formed by vaporizing a chemical intercalated in the graphite. In most cases, the chemical should be removed, preferably by heating, from the graphite by sufficient heating before mixing with polymers, since the chemical can degrade polymers. The expanded graphite can be formed in a radiofrequency wave applicator by heating the graphite precursor with microwave or radiofrequency waves. In some embodiments, a precursor graphite has been treated with a fuming oxy acid and heated to form the expanded graphite. The expanded graphite is then pulverized, and the pulverized particles are coated onto fibers to provide low resistivity graphite coated fibers.

Thus, the present invention provides a low resistivity graphite coated fiber comprising: an electrically insulating fiber having an outer surface; and exfoliated and pulverized graphite platelets having a particle size between about 0.1 and 500 microns coated on the outer surface of the electrically insulating fiber with a cationic or anionic polymer or mixtures thereof to provide the low resistivity graphite coated fiber. In further embodiments, the electrically insulating fiber is a glass fiber. In still further embodiments, the weight fraction of exfoliated nanographite platelets on the outer surface of the glass fiber is from about 0.01 wt % to about 1.0 wt %. In further still embodiments, the electrically insulating fiber is a polymer fiber.

The present invention further provides a reinforced composite material which comprises: a polymeric matrix; and a plurality of low resistivity graphite coated fibers mixed in the polymeric matrix, each of the low resistivity coated fibers comprising an electrically insulating fiber having an outer surface, and exfoliated and pulverized graphite platelets having a particle size between about 0.1 and 500 microns coated on the outer surface of the electrically insulating fiber with a cationic or anionic polymer or mixtures thereof, wherein the reinforced composite material enables electrostatic painting. In further embodiments, the electrically insulating fiber is a glass fiber. In still further embodiments, the weight fraction of exfoliated nanographite platelets on the outer surface of the glass fiber is from about 0.01 wt % to about 1.0 wt %. In further still embodiments, the electrically insulating fiber is a polymer fiber. In further still embodiments, the polymeric matrix comprises a thermoset or thermoplastic polymer.

The present invention provides a method of making a plurality of low resistivity graphite coated fibers comprising the steps of: providing a plurality of electrically insulating fibers; providing a graphite solution comprising exfoliated and pulverized graphite particles having a particle size between about 0.1 and 500 microns in a water based cationic or anionic polymer solution; coating the plurality of electrically insulating fibers with the graphite solution; and drying the sprayed fibers to provide the low resistivity graphite coated fibers.

The present invention provides a method of making a plurality of low resistivity graphite coated fibers comprising the steps of: providing a plurality of electrically insulating fibers; providing a graphite solution comprising exfoliated and pulverized graphite particles having a particle size between about 0.1 and 500 microns in a water based cationic or anionic polymer solution; spraying the graphite solution onto the plurality of electrically insulating fibers for a time to provide sprayed fibers; and drying the sprayed fibers to provide the low resistivity graphite coated fibers. In further embodiments, the graphite solution is 1 wt % of the exfoliated and pulverized graphite in water solution. In still further embodiments, the sprayed fibers are dried in step (d) at room temperature for more than twelve hours. In further still embodiments, the spraying time in step (c) is about ten seconds.

The present invention provides a method of making a plurality of low resistivity graphite coated fibers comprising the steps of: providing a plurality of electrically insulating fibers; providing a graphite solution comprising exfoliated and pulverized graphite particles having a particle size between about 0.1 and 500 microns mixed in a water based anionic or cationic polymer solution; dipping the plurality of fibers into the graphite solution; dipping the fibers into water to remove excess graphite solution; and drying the sprayed fibers to provide the low resistivity graphite coated fibers. In further embodiments, the graphite particles are ultrasonically mixed to provide the graphite solution in step (b). In still further embodiments, the fibers are as a bundle which is dipped into the graphite solution for about 1 to about 300 seconds. In further still embodiments, the graphite solution has a graphite concentration of 1 wt %. In further still embodiments, the fibers are dried in step (e) at room temperature.

The present invention provides a method of making a plurality of low resistivity graphite coated fibers comprising the steps of: providing a plurality of fibers; providing a first graphite solution comprising exfoliated and pulverized graphite particles mixed in a first water based cationic or anionic polymer solution; dipping the plurality of fibers into the first graphite solution; dipping the fibers into water to remove excess graphite solution; providing a second graphite solution comprising exfoliated and pulverized graphite particles mixed in a second water based cationic or anionic polymer solution which has a different cationic or anionic charge than the first graphite solution; dipping the fibers into the second graphite solution; and drying the sprayed fibers to provide the low resistivity graphite coated fibers.

In further embodiments, the first solution comprises a cationic polymer and the second solution comprises an anionic polymer. In still further embodiments, the first graphite solution comprises an anionic polymer and the second graphite solution comprises a cationic polymer. In still further embodiments, the exfoliated graphite particles are ultrasonically mixed into the water based anionic and cationic solutions to provide the graphite solutions in steps (b) and (e). In further still embodiments, glass fibers as a bundle are dipped into the water based graphite solution. In further still embodiments, the water based graphite solution has a graphite concentration of 1 wt %. In further still embodiments, the fibers are dipped into the cationic solution in step (c) for ten seconds. In further still embodiments, the fibers are dipped into the anionic solution in step (f) for ten seconds. In further still embodiments, the fibers are dried in step (g) at room temperature for more than twelve hours.

The present invention provides a method of electrostatic painting a reinforced composite material without using a conductive primer comprising the steps of: providing an electrically conductive reinforced composite material which comprises a polymeric matrix; and a plurality of low resistivity graphite coated fibers mixed in the polymeric matrix, each of the low resistivity coated fibers comprising an electrically insulating fiber having an outer surface; and exfoliated and pulverized graphite platelets having a particle size between about 0.1 and 500 microns coated on the outer surface of the electrically insulating fiber with a cationic or anionic polymer or mixtures therein to provide the low resistivity graphite coated fiber, wherein the reinforced composite material has sufficient conductivity to undergo electrostatic painting and to provide EMI and RF shielding; electrically grounding the reinforced composite material; providing a charged powder comprising a resin and a pigment; spraying the charged powder onto the electrically grounded reinforced composite material so as to coat the material; and curing the powder on the reinforced composite material in a curing oven, so as to electrostatically paint the reinforced composite material with the powder. In further embodiments, the fiber is a glass fiber.

The present invention relates to a low resistivity graphite coated fiber comprising: (a) an electrically insulating fiber having an outer surface; and (b) exfoliated and pulverized graphite platelets having a particle size between about 0.1 and 500 microns coated on the outer surface of the electrically insulating fiber to provide the low resistivity graphite coated fiber.

Further, the present invention relates to a reinforced composite material which comprises: (a) a polymeric matrix; and (b) a plurality of low resistivity graphite coated fibers mixed in the polymeric matrix, each of the low resistivity coated fibers comprising an electrically insulating fiber having an outer surface, and exfoliated and pulverized graphite platelets having a particle size between about 0.1 and 500 microns coated on the outer surface of the electrically insulating fiber, wherein the reinforced composite material enables electrostatic painting.

Further still, the present invention relates to a method of making a plurality of low resistivity graphite coated fibers comprising the steps of: (a) providing a plurality of electrically insulating fibers; (b) providing a graphite solution comprising exfoliated and pulverized graphite particles having a particle size between about 0.1 and 500 microns in a solution; (c) coating the plurality of electrically insulating fibers with the graphite solution; and (d) drying the sprayed fibers to provide the low resistivity graphite coated fibers.

Still further, the present invention relates to a method of making a plurality of low resistivity graphite coated fibers comprising the steps of: (a) providing a plurality of electrically insulating fibers; (b) providing a graphite solution comprising exfoliated and pulverized graphite particles having a particle size between about 0.1 and 500 microns in a solution; (c) spraying the graphite solution onto the plurality of electrically insulating fibers for a time to provide sprayed fibers; and (d) drying the sprayed fibers to provide the low resistivity graphite coated fibers.

Further, the present invention relates to a method of making a plurality of low resistivity graphite coated fibers comprising the steps of: (a) providing a plurality of electrically insulating fibers; (b) providing a graphite solution comprising exfoliated and pulverized graphite particles having a particle size between about 0.1 and 500 microns mixed in a solution; (c) dipping the plurality of fibers into the graphite solution; (d) dipping the fibers into water to remove excess graphite solution; and (e) drying the sprayed fibers to provide the low resistivity graphite coated fibers.

Finally, the present invention relates to a method of electrostatic painting a reinforced composite material without using a conductive primer comprising the steps of: (a) providing an electrically conductive reinforced composite material which comprises a polymeric matrix; and a plurality of low resistivity graphite coated fibers mixed in the polymeric matrix, each of the low resistivity coated fibers comprising an electrically insulating fiber having an outer surface; and exfoliated and pulverized graphite platelets having a particle size between about 0.1 and 500 microns coated on the outer surface of the electrically insulating fiber to provide the low resistivity graphite coated fiber, wherein the reinforced composite material has sufficient conductivity to undergo electrostatic painting and to provide EMI and RF shielding; (b) electrically grounding the reinforced composite material; (c) providing a charged powder comprising a resin and a pigment; (d) spraying the charged powder onto the electrically grounded reinforced composite material so as to coat the material; and (e) curing the powder on the reinforced composite material in a curing oven, so as to electrostatically paint the reinforced composite material with the powder.

### BRIEF DESCRIPTION OF THE DRAWINGS

FIG. 1 is a histogram of the thermal conductivity of epoxy reinforced with various conductive particles.

FIG. 2 is a histogram of the coefficient of thermal expansion of epoxy reinforced with various conductive particles.

FIG. 3 is an illustration of dip coating of glass fibers 10.

FIG. 4 is an illustration of spray coating of glass fibers 10.

FIG. 5 is a graph illustrating the log (resistance) vs. log (frequency) of coated glass fibers. A=Raw glass fiber; B=0.2 wt % xGnP PDAC/PSSS coated glass fiber; C=0.2 wt % xGnP PSSS/PDAC coated glass fiber; D=0.2 wt % xGnP SDBS coated glass fiber; E=0.2 wt % xGnP PDAC coated glass fiber; F=0.2 wt % xGnP PSSS coated glass fiber.

FIG. 6 is a histogram illustrating the log (resistivity) at 1 Hz of coated glass fibers. A=Raw glass fiber; B=0.2 wt % xGnP PDAC/PSSS coated glass fiber; C=0.2 wt % xGnP PSSS/PDAC coated glass fiber; D=0.2 wt % xGnP SDBS coated glass fiber; E=0.2 wt % xGnP PDAC coated glass fiber; F=0.2 wt % xGnP PSSS coated glass fiber.

FIG. 7 is an ESEM image of a 0.2% xGnP/PDAC coated glass fiber.

FIG. 8 is an ESEM image of an 0.2% xGnP/PSSS coated glass fiber.

FIG. 9 is an ESEM image of an 0.2% xGnP/PSSS and 0.2% xGnP/PDAC coated glass fiber (3 cycles).

FIG. 10 is an ESEM image of an 0.2% xGnP/PDAC and 0.2% xGnP/PSSS coated glass fiber (3 cycles).

FIG. 11 is a graph illustrating the log (resistance) vs. log (frequency) of coated glass fibers. A=Raw glass fiber; B=1 wt % xGnP SDBS coated glass fiber; C=1 wt % xGnP PSSS coated glass fiber; D=1 wt % xGnP PDAC coated glass fiber; E=1 wt % xGnP PDAC/PSSS coated glass fiber (3 cycles); F=1 wt % xGnP PSSS/PDAC coated glass fiber (3 cycles).

FIG. 12 is a histogram illustrating the log (resistivity) at 1 Hz of coated glass fibers. A=Raw glass fiber; B=1 wt % xGnP SDBS coated glass fiber; C=1 wt % xGnP PSSS coated glass fiber; D=1 wt % xGnP PDAC coated glass fiber; E=1 wt % xGnP PDAC/PSSS coated glass fiber (3 cycles); F=1 wt % xGnP PSSS/PDAC coated glass fiber (3 cycles).

FIG. 13 is an ESEM image of a 1 wt % xGnP/SDBS coated glass fiber.

FIG. 14 is an ESEM image of a 1 wt % xGnP/PSSS coated glass fiber.

FIG. 15 is an ESEM image of a 1 wt % xGnP/PDAC coated glass fiber.

FIG. 16 is an ESEM image of a 1 wt % xGnP/PDAC and 1 wt % xGnP/PSSS coated glass fiber (3 cycles).

FIG. 17 is an ESEM image of a 1 wt % xGnP/PSSS and 1 wt % xGnP/PDAC coated glass fiber (3 cycles).

FIG. 18 is a graph illustrating the log (resistance) vs. log (frequency) of coated glass fibers. A=Raw glass fiber; B=1 wt % xGnP SDBS dipping coated glass fiber; C=1 wt % xGnP PSSS dipping coated glass fiber; D=1 wt % xGnP PDAC dipping coated glass fiber; E=1 wt % xGnP SDBS spray coated glass fiber; F=1 wt % xGnP PSSS spray coated glass fiber; G=1 wt % xGnP PDAC spray coated glass fiber.

FIG. 19 is a histogram illustrating the log (resistivity) at 1 Hz of coated glass fibers. A=Raw glass fiber; B=1 wt % xGnP SDBS dipping coated glass fiber; C=1 wt % xGnP PSSS dipping coated glass fiber; D=1 wt % xGnP PDAC dipping coated glass fiber; E=1 wt % xGnP SDBS spray coated glass fiber; F=1 wt % xGnP PSSS spray coated glass fiber; G=1 wt % xGnP PDAC spray coated glass fiber.

FIG. 20 is an ESEM image of a 1 wt % xGnP/PDAC coated glass fiber

FIG. 21 is an ESEM image of a 1 wt % xGnP/PSSS coated glass fiber.

FIG. 22 is a plot of weight (%) vs. temperature (° C.) illustrating the TGA behavior of pure xGnP and xGnP coated glass fiber.

FIG. 23 is a plot of weight (%) vs. temperature (° C.) illustrating the TGA behavior of a 1.0 wt % xGnP/PDAC/PSSS coated glass fiber (3 cycles).

FIG. 24 is a histogram illustrating the log (resistivity) at 1 Hz of multiple layer coated glass fibers. A=Raw glass fiber; B=1% xGnP PSSS coated glass fiber; C=1% xGnP PDAC/PSSS coated glass fiber 1 cycles; D=1% xGnP PDAC/PSSS coated glass fiber 3 cycles; E=1% xGnP PDAC/PSSS coated glass fiber 5 cycles; F=1% xGnP PDAC coated glass fiber; G=1% xGnP PSSS/PDAC coated glass fiber 1 cycles; H=1% xGnP PSSS/PDAC coated glass fiber 3 cycles; I=1% xGnP PSSS/PDAC coated glass fiber 5 cycles.

### DESCRIPTION OF PREFERRED EMBODIMENTS

All patents, patent applications, government publications, government regulations, and literature references cited in this specification are hereby incorporated herein by reference in their entirety. In case of conflict, the present description, including definitions, will control.

As used herein the abbreviation “PSSS” refers to anionic (−) poly(sodium 4-styrene sulfonate), which is a vinyl polymer.

As used herein the abbreviation “PDAC” refers to cationic (+) poly(diallyldimethylammonium chloride), which is a vinyl polymer.

As used herein the term “anionic polyelectrolyte” refers to any anionic polymer known in the art, including but not limited to poly(sodium 4-styrene sulfonate) (PSSS). The term “anionic polymer” refers to any polymer, organic or inorganic, having repeating subunits with negatively charged groups along the polymer chain.

As used herein the term “cationic polyelectrolyte” refers any cationic polymer known in the art, including but not limited to poly(diallyldimethylammonium chloride) (PDAC). The term “cationic polymer” refers to any polymer, organic or inorganic, having repeating subunits with positively charged groups along the polymer chain.

As used herein the term “electrically insulating fiber” refers to any fiber with an electronic resistance that increases with decreasing frequency. Some examples include glass fibers or polymer fibers. The term “fiber” refers to any fiber, such as but not including, glass and polymer fibers.

As used herein the term “low resistivity graphite coated fiber” refers to a fiber coated with exfoliated and pulverized graphite platelets that has a resistivity at a frequency of 1 Hz that is lower than the resistivity of an untreated (raw) fiber.

As used herein the term “reinforced composite material” refers to a composite material having added reinforcements. The composite material can comprise any thermoset or thermoplastic polymeric matrix known in the art. For example, the term “SMC” refers to sheet molding compound, a glass fiber reinforced polymeric material formed by compression molding.

As used herein the abbreviation “CF” refers to carbon fibers.

As used herein the abbreviations “VGCF” or “vgCF” refer to vapor grown carbon fibers.

As used herein the abbreviation “CB” refers to particulate carbon black.

As used herein the abbreviation “PAN” refers to polyacrylonitrile.

Graphite is a layered material that is a very good thermal and electrical conductor. Individual molecular layers of graphite are held together with weak Van der Waals forces that are capable of being intercalated with organic or inorganic molecules. The intercalated molecules can be used for separation of the graphite layers to form expanded graphite. An expanded graphite is one that has been heated to separate individual platelets of graphite. An exfoliated graphite is a form of expanded graphite where the individual platelets are separated by heating with or without an agent such as a polymer or polymer component. The graphite expands to form very large platelets having large diameters and very thin thicknesses. The expanded graphite usually does not have any significant order as evidenced by x-ray diffraction patterns. The exfoliated graphite is pulverized to form the nanographite platelets. As used herein the abbreviation “xGnP” refers to exfoliated nanographite platelets. Exfoliated nanographite platelets (xGnP) are exfoliated and pulverized graphite to a particle size between about 0.1 and 500 microns.

Expanded graphite results in superior mechanical properties and in addition has desirable electrical properties if a sufficient amount of the expanded graphite is present in a polymer matrix. Expanded graphite platelets have interbasal plane surfaces with reactive sites on the edges of the platelets. Different chemical groups can be added to the edges. The application of an electric field can also be used to orient the expanded graphite platelets in a preferred direction creating materials which are electrically or thermally conductive in one direction. Submicron conductive paths can thus be created to act as nanosized wires.

The use of microwave (MW) energy or radiofrequency (RF) induction heating provides a fast and economical method to produce expanded graphite nanoflakes, graphite nanosheets, or graphite nanoparticles. The microwave or radiofrequency methods are especially useful in large-scale production and are very cost-effective. The combination of radiofrequency or microwave expansion and appropriate grinding technique, such as planetary ball milling (and vibratory ball milling), produces nanoplatelet graphite flakes with a high aspect ratio efficiently. Microwave or radiofrequency expansion and pulverization of the crystalline graphite to produce suitable graphite flakes enables control of the size distribution of graphite flakes more efficiently. By incorporating an appropriate surface treatment, the process offers an economical method to produce a surface treated expanded graphite.

Chemically intercalated graphite flakes are expanded by application of the radiofrequency or microwave energy. The expansion occurs rapidly. Heating for three to five minutes removes the expanding chemical. The graphite absorbs the radiofrequency or microwave energy very quickly without being limited by convection and conduction heat transfer mechanisms. The intercalant heats up past the boiling point and causes the graphite to expand to many times its original volume. The process can be performed continuously by using a commercially available induction or microwave system with conveyors. Although a commercial microwave oven operating at 2.45 GHz was used for the following experiments, radio frequency (induction heating) or microwave frequency energy across a wide range can be used for this purpose.

The expanded graphite is pulverized for instance by ball milling, mechanical grinding, air milling, or ultrasonic wave to produce graphite flakes (platelets) with high aspect ratio. These flakes are used as reinforcements in various matrices including polymers and metals. Also these flakes can be used, for instance, as anode materials, or substrates for metal catalysts. The exfoliated graphite flakes can be provided in a polymer matrix composite to improve the mechanical, electrical and thermal properties. In some embodiments the intercalated graphite flakes are expanded by application of microwave energy at 2.45 GHz. Exfoliated and pulverized graphite and methods of producing the exfoliated and pulverized graphite are described in U.S. Patent Application Publication No. 2004/0127621 to Drzal et al. (copending U.S. patent application Ser. No. 10/659,577), filed Sep. 10, 2003, hereby incorporated herein by reference in its entirety. This microwave expansion process can be done continuously by using a commercially available microwave system with conveyors or the other devices as described in U.S. patent application Ser. No. 11/435,350, filed May 16, 2006, hereby incorporated herein by reference in its entirety.

Our research has shown that natural graphite can be exfoliated to produce nano sized platelets of graphite that can be dispersed in either organic or water based systems. In experiments conducted with both thermoset and thermoplastic polymers, exfoliated graphite nanoplatelets (xGnP) have been successfully dispersed and their mechanical, electrical, barrier and thermal properties have been measured. It was found that as little as three (3) volume percent of the xGnP reduced the AC impedance by a factor of 109-1010, a level sufficient to not only provide electrostatic charge dissipation, but also to decrease the electrical resistance to the point where the polymer composite has sufficient conductivity to undergo electrostatic painting and to function for electromagnetic interference (EMI) shielding.

The composite material can be applied to thermoset polymer systems, such as epoxy, polyurethane, polyurea, polysiloxane and alkyds, where polymer curing involves coupling or crosslinking reactions. The composite material can be applied as well to thermoplastic polymers for instance polyamides, proteins, polyesters, polyethers, polyurethanes, polysiloxanes, phenol-formaldehydes, urea-formaldehydes, melamine-formaldehydes, celluloses, polysulfides, polyacetals, polyethylene oxides, polycaprolactams, polycaprolactons, polylactides, polyimides, and polyolefins (vinyl-containing thermoplastics). Specifically included are polypropylene, nylon and polycarbonate. The polymer can be for instance an epoxy resin. The epoxy resin cures when heated. The epoxy composite material preferably contains less than about 8% by weight of the expanded graphite platelets. Thermoplastic polymers are widely used in many industries.

Nanolayers of the exfoliated graphite on glass fibers and their efficacy at improving the conductivity of the coated glass fibers is described herein. The effect of nanographite platelet size, concentration and surface chemistry on the conductivity of glass fibers and the resulting SMC or other recommended composite system is described. These results can be extended to the glass fiber sizing/finish solution to produce a level of conduction on glass fibers and fillers applicable to production methods. Furthermore, the electrical conductivity, mechanical properties and processability of the selected formulation (SMC or thermoplastic system) of the xGnP coated glass fiber can be optimized.

Epoxy matrix composites have been successfully fabricated using exfoliated graphite nanoplatelets (xGnP) of various diameters and at various concentrations up to three volume percent (3 vol %) as described in U.S. Patent Application Publication No. 2004/0127621 to Drzal et al. (copending U.S. patent application Ser. No. 10/659,577), filed Sep. 10, 2003. A flexural modulus of approximately 3.9 GPa could be attained with the xGnP which was significantly greater than composites reinforced with carbon fibers (CF), vapor grown carbon fibers (vgCF) and particulate carbon black (CB) at the same concentrations. Concentrations of up to twenty-five volume percent (25 vol %) can be attained with a modulus of approximately 12 GPa. The surface chemistry of the xGnP is important also. The flexural modulus of the acrylonitrile grafted surface has superior properties to the other surface treatments of xGnP.

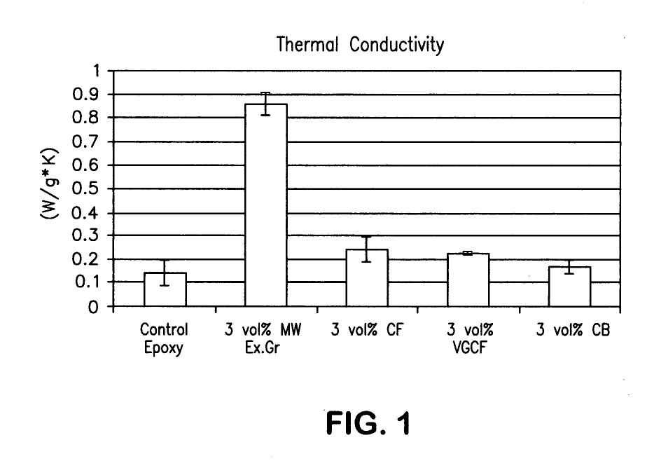

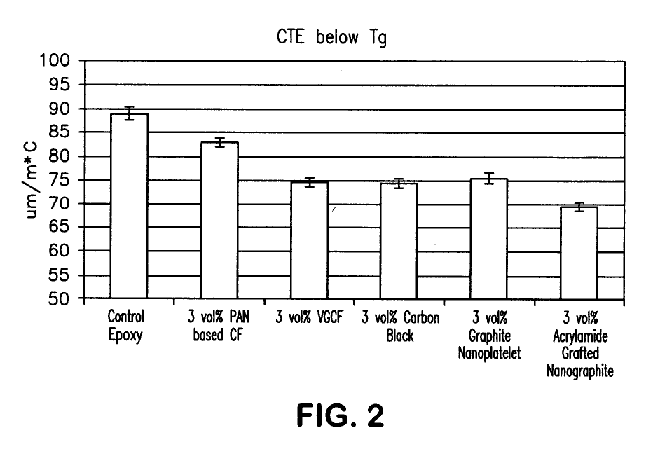

The thermal and electrical properties of composites made from these reinforcements also showed significant differences based on the reinforcements size concentrations and morphology. Thermal conductivity measurements, illustrated in FIG. 1, show that large exfoliated nanographite platelets can attain higher thermal conductivities than fibrous reinforcements or carbon black at the same concentration. Furthermore there is a corresponding reduction in the coefficient of thermal expansion, as illustrated in FIG. 2. Recent results at higher concentrations have reduced the coefficient of thermal expansion (CTE) to approximately forty.

AC Impedance measurements detected a reduction of approximately ten orders of magnitude in the composites made from xGnP at a concentration of two volume percent (2 vol %), similar to the CB, vgCF and CF required concentrations to eight and twelve volume percent respectively to produce the same reduction in impedance. The small concentration necessary for percolation and the large reduction in impedance are significant. This value is well beyond what is required for electrostatic spraying and into the regime where these materials would show electromagnetic interference (EMI) and radiofrequency (RF) shielding properties. Exfoliated graphite nanoplatelets can be produced as large, thin sheets. They can be produced inexpensively, suspended in water or organic solvent, deposited onto surfaces, dispersed in thermoset or thermoplastic polymers, and used to increase electrical conductivity. The ability to produce an electrically conductive SMC would provide significant advantages for the automobile industry. The use of a conductive primer could be eliminated and electrostatic painting could be accomplished directly on the SMC part. Also, an SMC with EM shielding could be produced. Each of these contribute to the increased economic and performance attractiveness of SMC.

Since material electrical conductivity is largely dominated by surface conduction mechanisms, the ability to deposit xGnP on glass fibers in nanolayers thicknesses creates a unique opportunity to increase the conductivity of glass fibers without a significant increase in cost, change in composition, or change in processing. The xGnP can be dispersed in the sizing/finishing solution and applied to the glass fibers emerging from the production die in a manner similar to current sizing/finishing application procedures with little if any modification to the process.

The following stepwise approach is taken herein. First, the ability to deposit xGnP onto glass fibers from a water based solution is demonstrated. Second, the amount of xGnP that must be deposited on the fiber surface to increase the glass fiber electrical conductivity to levels suitable for electrostatic painting is determined. Third, the resin system to be used is selected. Fourth, it is demonstrated that xGnP can be applied to the glass fiber from sizing/finish solution and produce a level of conduction sufficient for direct electrostatic painting of SMC or thermoplastic composites. Fifth, the electrical conductivity, mechanical properties and processability of the selected formulation (SMC or thermoplastic system) of the xGnP coated glass fiber is investigated and optimized.

Electrostatic painting can thereby be accomplished on a reinforced composite material without using a conductive primer. An electrically conductive reinforced composite material of the present invention comprises a polymeric matrix and low resistivity graphite coated fibers mixed in the polymeric matrix. Each of the low resistivity coated fibers have exfoliated and pulverized graphite platelets on the outer surface of the fiber. The reinforced composite material has sufficient conductivity to undergo electrostatic painting and to provide EMI and RF shielding. To perform electrostatic painting the reinforced composite material is electrically grounded. A charged powder with a resin and a pigment is sprayed onto the electrically grounded reinforced composite material so as to coat the material. Next, the powder on the reinforced composite material is cured in a curing oven. Electrostatic painting apparatuses and methods are described in U.S. Pat. No. 4,660,771 to Chabert et al, U.S. Pat. No. 6,455,110 to Fortuyn et al., U.S. Pat. No. 6,659,367 to Ballu, and U.S. Pat. No. 6,776,362 to Kawamoto et al., each of which is hereby incorporated herein by reference in its entirety.

Various surfactants have been found to produce suspensions of xGnP in water that are stable for periods of up to several weeks. Drops of these xGnP suspensions have been deposited on silicon wafers and spin coated. Atomic Force Microscopy (AFM) characterization of these surfaces shows that the xGnP are dispersed uniformly over the surface. Approximately ten micron (˜10 μm) water sized glass fibers were repetitively immersed in the xGnP suspensions in the following Examples. The surfaces were then examined with AFM and environmental scanning electron microscopy (ESEM) to determine the ability of the solution to produce a uniform coating as a function of the number of immersions. The increase in weight of the fiber after immersion was then measured on a gravimetric balance. Surface conductivity measurements were conducted in parallel with the coating experiments. The electrical resistance of selected fibers can be measured over a twenty-five millimeter (25 mm) gage length to determine the surface concentration that is required to produce a substantial change in surface conductivity.

It has been shown herein in the following Examples that glass fibers can be quickly and conveniently coated with conductive, exfoliated nanographite platelets (xGnP) through a variety of means so that the glass fibers exhibit acceptable levels of electrical conductivity. As a result of this the following conclusions can be made. First, xGnP can be coated on the surface of glass fiber with a variety of methods and chemical processes, such as dipping the glass fiber into a water based suspension of a polyelectrolyte with xGnP, and spraying the water based suspension of a polyelectrolyte with xGnP. Second, the electrical resistance of the glass fiber was reduced to levels that made the graphite coated glass fiber conductive for electrostatic spraying, and the resulting conductivity depends upon the concentration of graphite and polyelectrolyte. Third, one layer of graphite coating is more effective and results in better conductivity than multi-layer graphite coatings. Fourth, the amount of graphite coated on glass fiber resulting in the best conductivity is preferably only about 0.16 to about 0.2 weight percent (wt %) of the fibers. In some embodiments, the amount can be between about 0.01 and 1.0 percent by weight (wt %) of the fibers. These conclusions are based upon experimental results as described fully in the following Examples.

### EXAMPLES

Materials: Poly(Sodium 4-Styrene Sulfonate) (PSSS) with molecular weight of 70,000, poly(diallyldimethylammonium chloride) (PDAC) with molecular weight of 400,000-500,000 (20% in solution), and sodium dodecylbenzene sulfonate (SDBS) were purchased from Sigma-Aldrich (St. Louis, Mo.). Glass fibers were supplied by Johns Manville (Denver, Colo.). One micron (1 μm) size exfoliated graphite nanoplatelets (xGnP-1) were processed at the Composite Materials and Structures Center, Michigan State University (East Lansing, Mich.). The graphite was exfoliated and pulverized as described in U.S. Patent Application Publication No. 2004/0127621 to Drzal et al. (copending U.S. patent application Ser. No. 10/659,577), filed Sep. 10, 2003.

Sample preparation: Preparation of water based graphite solution is performed as follows. Predetermined amounts of xGnP, deionized (DI) water and polyelectrolyte (surfactant) were ultrasonically mixed for ten minutes (10 min), to produce 0.2 wt % and 1.0 wt % xGnP-1 water based solution. Detailed formulation information is shown in Table 1.

TABLE 1
Composition of water based xGnP solution.

| | Composition | | | | Weight | Weight |
|---|---|---|---|---|---|---|
| | DI | | | | fraction | fraction of |
| | water | Polyelectrolyte | | 1-μm | of xGnP | PE/SDBS |
| # | (g) | (PE) (g) | SDBS (g) | xGnP (g) | (%) | (%) |
| 1 | 50 | — | 0.1 | 0.1 | 0.2 | 0.2 |
| 2 | 50 | PDAC 0.1 | — | 0.1 | 0.2 | 0.2 |
| 3 | 50 | PSSS 0.1 | — | 0.1 | 0.2 | 0.2 |
| 4 | 50 | — | 0.25 | 0.5 | 1.0 | 0.5 |
| 5 | 50 | PDAC 0.25 | — | 0.5 | 1.0 | 0.5 |
| 6 | 50 | PSSS 0.25 | — | 0.5 | 1.0 | 0.5 |

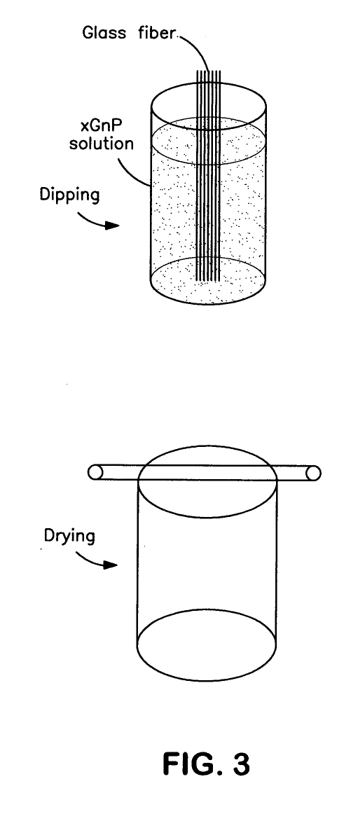

Dip coating of the glass fibers: A schematic illustrating the dip coating of glass fibers is shown in FIG. 3. The glass fiber bundle is dipped into the water based graphite solution for sixty (60) seconds at graphite concentration of 0.2 wt % and 1 wt %, using a self assembly layer by layer technology. One (1) dipping cycle includes first dipping into the positive charged polymer solution for ten seconds (10 s) and then dipping into water to remove excess polymer, followed by a second dipping into negative charged polymer solution for ten seconds. Finally, the fiber bundle is removed and dried at room temperature for more than twelve hours.

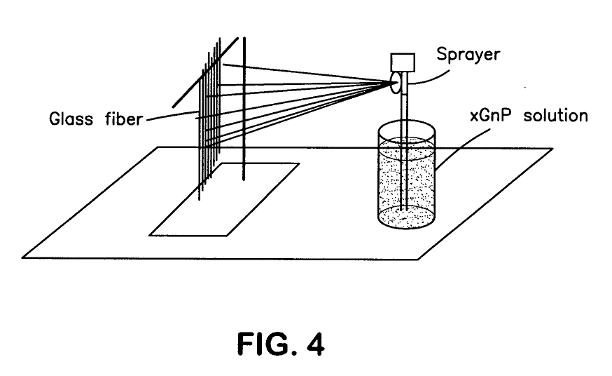

Spray coating of the glass fibers: A schematic illustration of spray coating glass fibers is shown in FIG. 4. In one embodiment, a plastic sprayer 10 can be used to spray the 1 wt % water based graphite solution 20 (xGnP) onto the surface of hung glass fibers 30. In one embodiment, the spraying time is about ten seconds. Next, the fiber bundle is dried at room temperature for more than twelve hours.

### Characterization.

Electrical properties: The resistance of raw and xGnP coated glass fiber was measured by Impedance Spectroscopy by applying a two-probe method at room temperature. The length of glass fiber was twenty-five millimeters (25 mm). The resistivity then was calculated by followed equation: Resistivity=Resistance*W/L (surface resistivity), where W is the width of glass fiber (refers to the punch glass fibers width=2000*n*D), and L is the length of glass fiber (25 mm).

Morphology: The surface of xGnP coated glass fiber was observed by means of Environmental Scanning Electron Microscopy (ESEM) using a Philips Electroscan 2020 with accelerating voltage of 20 KV.

TGA analysis: A thermogravimetric analyzer (2950 TGA, TA instruments, USA) was used to measure the decomposition behavior of xGnP and xGnP coated glass fiber under air gas with heat rate of 10° C./min.

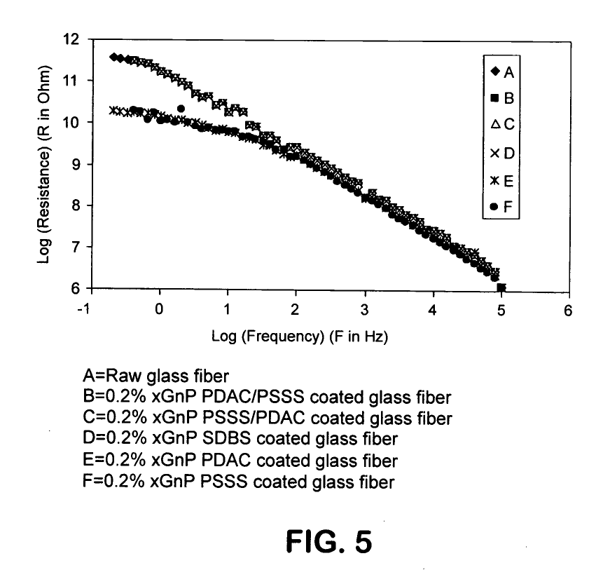

Results: The resistance (AC impedance) from electrochemical impedance spectroscopy is shown in FIG. 5. It was found that electronic resistance had a lower value at higher frequencies, and the resistance increased with decreasing frequency. This is a typical characteristic of an insulator. Raw and xGnP coated glass fibers displayed a similar trend. This data suggests that all of the coated glass fibers are not conductive.

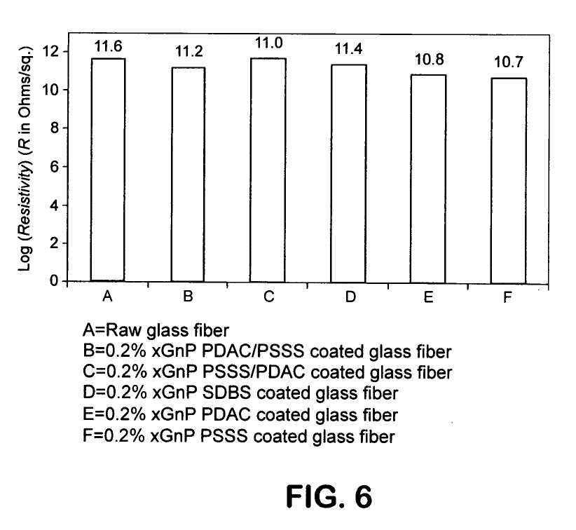

The resistivity of coated glass fibers at a frequency of 1 Hz is shown in FIG. 6. It is clear that the resistivity of glass fibers coated with 0.2 wt % xGnP solution was only marginally reduced. This data indicates that 0.2 wt % water based xGnP solution is not enough to reduce the resistivity of glass fiber.

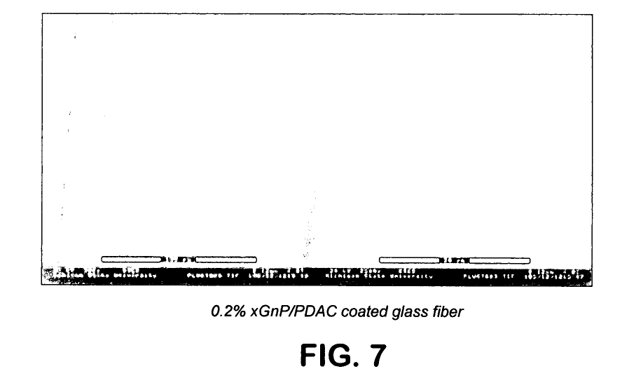

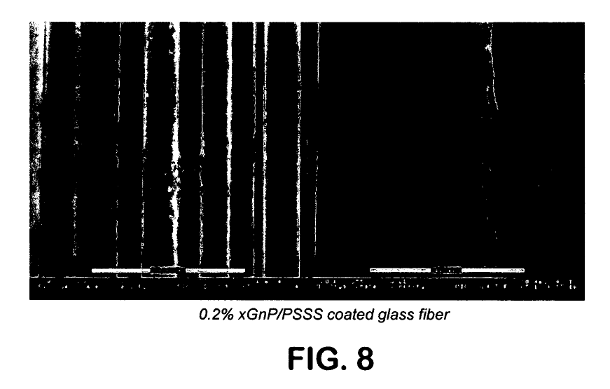

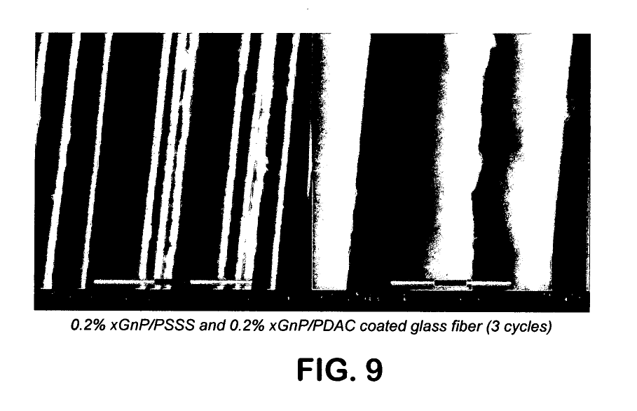

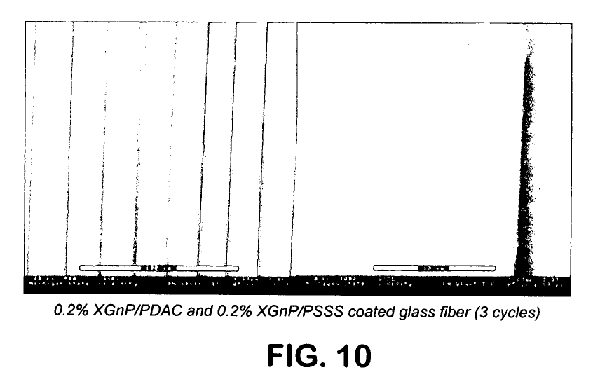

The ESEM image of xGnP a graphite coated glass fiber is shown in FIG. 7 through FIG. 10. Exfoliated graphite nanoplatelets (xGnP) were found attached on the glass fiber surface when using the water based solution. The solutions included xGnP water based SDBS solution, xGnP water based PDAC solution, and xGnP water based PSSS solution. These results illustrate that xGnP has the ability to be coated on the surface of glass fiber. Using the selfassembling technology, even after six layers of xGnP were coated on the glass fiber surface, the coating of xGnP was not continuous on the glass fiber surface. This result suggests that the concentration of the xGnP water based solution is not high enough to coat the glass fiber and thus does not result in enough xGnP material on the glass fiber surface to reduce the resistivity. Therefore, it is necessary to increase the concentration of xGnP water based solution.

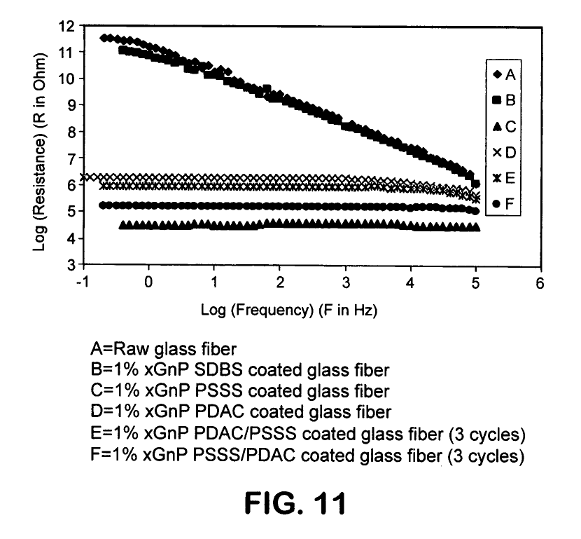

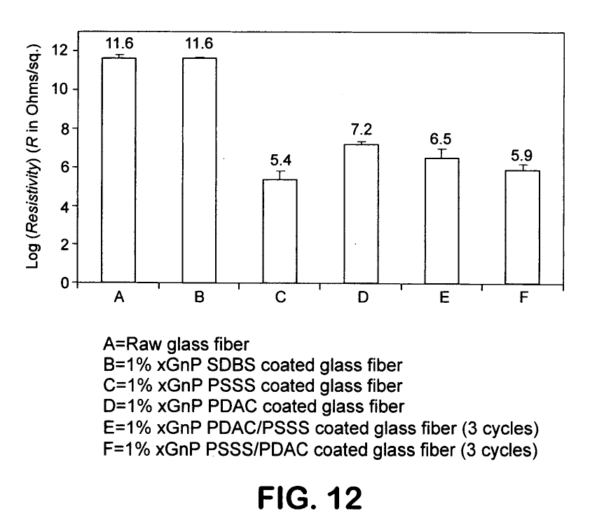

The AC impedance behavior of raw and coated glass fibers, using a 1.0 wt % xGnP water based solution, are shown in FIG. 11. It was found that using a 1.0 wt % xGnP water based SDBS surfactant solution to coat glass fibers did not change the impedance behavior, as compared with raw glass fiber. This shows that the xGnP water based surfactant solution does not work well for coating of the glass fiber surface. However, glass fiber coated with xGnP using PSSS, PDAC or an alternating layer-by-layer approach, significantly improved the conductivity. The resistance creases by six orders of magnitude and was constant over the entire range of frequencies. This is a typical feature of conductive materials. In this case, the xGnP coating makes glass fiber conductive. The resistance of glass fiber is reduced by using a 1.0 wt % xGnP water based polyelectrolyte solution coating. The resistivity of the various coated glass fibers at 1 Hz is shown in FIG. 12. The resistivity of glass fiber significantly decreased about six orders using appropriate xGnP water based solutions. It was found that using the self-assembling layer-by-layer technology is not helpful to reduce the resistivity of glass fiber.

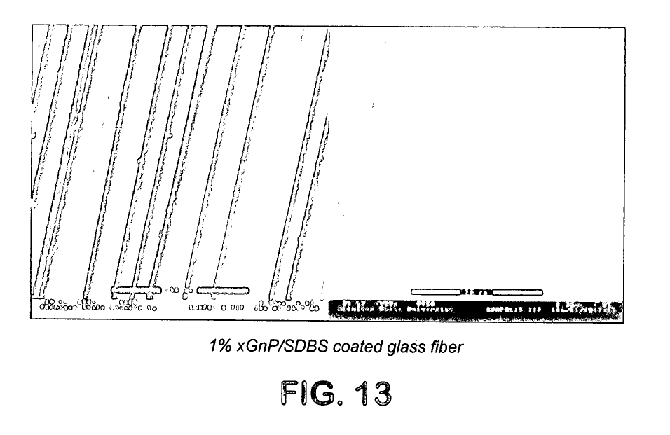

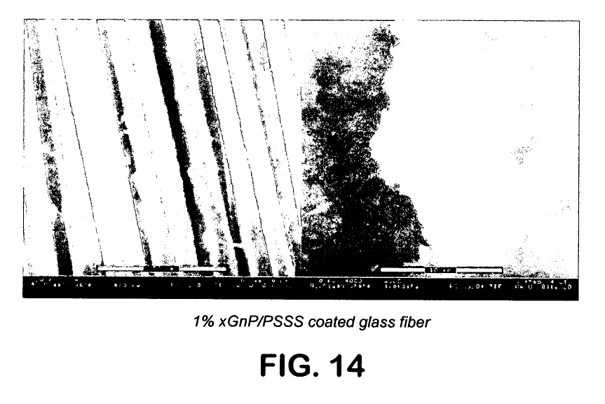

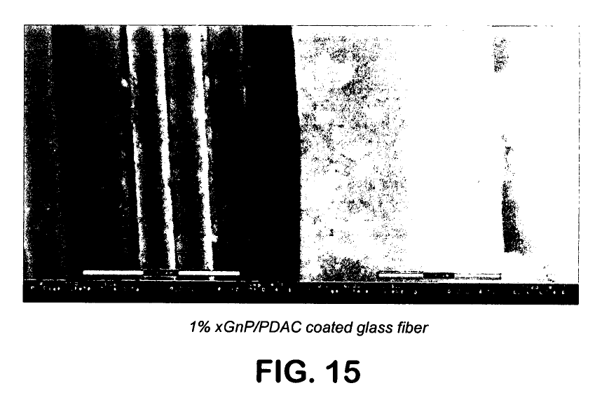

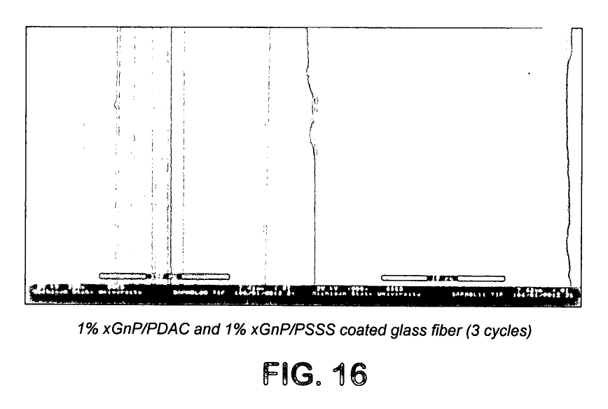

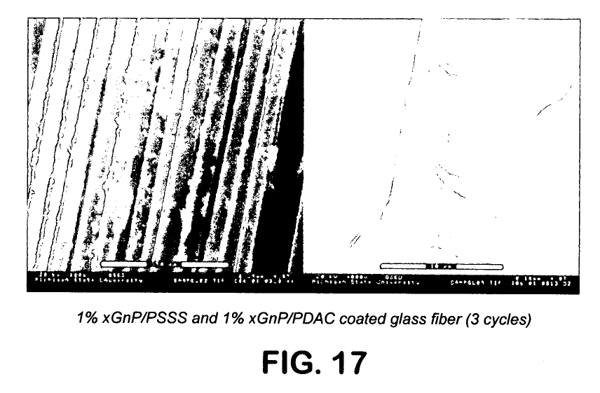

The ESEM images of 1.0 wt % xGnP water based solution are shown in FIG. 13 through FIG. 17. One weight percent (1.0 wt %) xGnP water based SDBS solution coated glass fiber produces a discontinuous coating of xGnP on glass fiber as shown in FIG. 13. This means that increasing only the xGnP content is not enough to reduce the resistivity of the glass fiber. More importantly, is the interaction between the water based solution and the glass fiber. One weight percent (1.0 wt %) xGnP water based PSSS solution coated glass fiber, as shown in FIG. 14, has many xGnP particles attached to the outer surface that form a continuous coating. This result explains why this fiber is conductive. Similarly, 1.0 wt % xGnP water-based PDAC solution, a 1.0 wt % xGnP/PDAC and 1.0 wt % xGnP/PSSS (3 cycle coating), and a 1.0 wt % xGnP/PSSS and 1.0 wt % xGnP/PDAC (3 cycle coating) graphite coated glass fibers, as illustrated in FIGS. 15 to 17, have a continuous xGnP coating on the glass fiber surface.

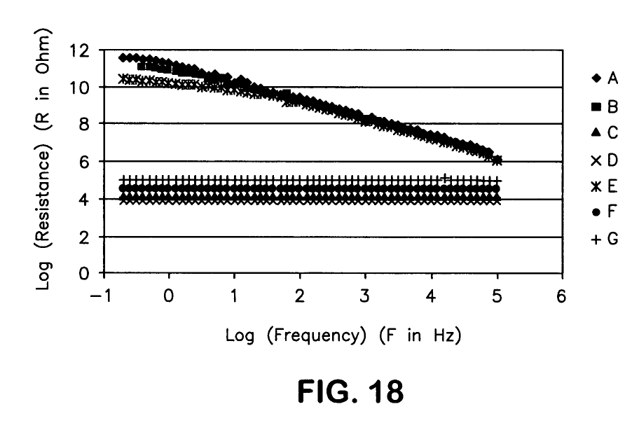

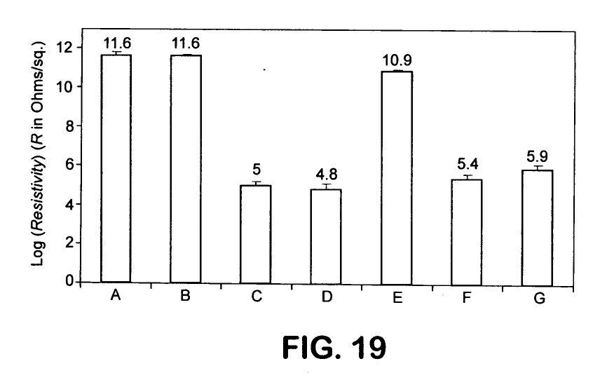

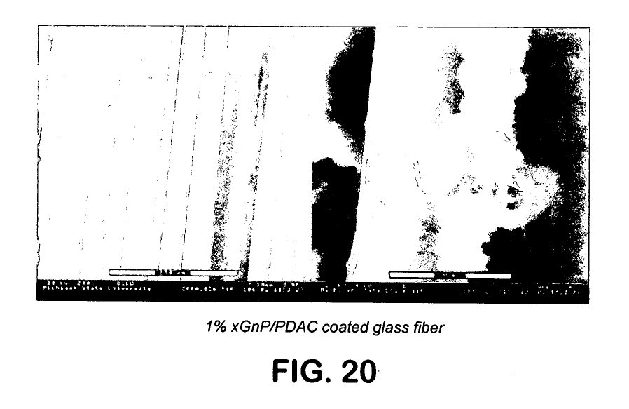

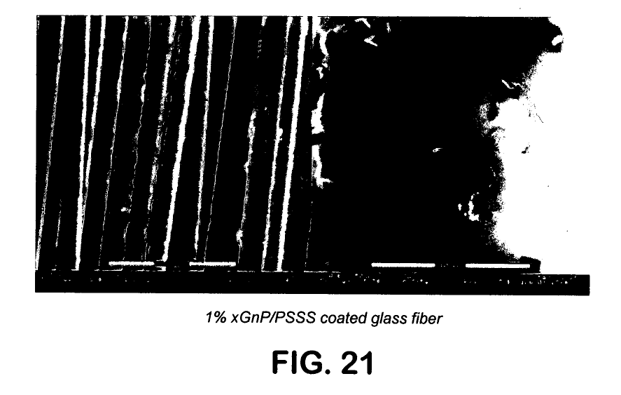

Dip coating on glass fiber surfaces does work well, so spray coating xGnP on glass fiber surface has also been investigated. Spray coating is an alternative coating process that can create an industrially more robust process. The AC impedance behavior and resistivity at 1 Hz of 1.0 wt % xGnP spray coated glass fibers is shown in FIGS. 18 and 19. It was found that a 1.0 wt % xGnP water-based PSSS and PDAC solution coating significantly reduced the resistance and resistivity of glass fiber. However, spray coating with a 1.0 wt % xGnP water based SDBS solution did not change the resistivity of glass fiber. This demonstrates that spray coating of xGnP onto glass fiber surfaces can produce a similar resistivity to that which is produced by dip coating xGnP of the glass fibers. The ESEM image of 1.0 wt % xGnP spray coated glass fiber, as illustrated in FIGS. 20 and 21, shows that graphite nanoplatelets clearly coat the entire glass fiber surface. The coating appears to be a homogenous coating on the glass fiber surface. This result suggests that the spray coating of the xGnP onto glass fiber surfaces can be used in an industrial application that can be directly inserted into the industrial production of glass fibers. Apparatuses and methods for coating elongated fibers are described in U.S. Pat. No. 5,042,111 to Iyer et al., U.S. Pat. No. 5,042,122 to Iyer et al., U.S. Pat. No. 5,102,690 to Iyer et al., U.S. Pat. No. 5,123,373 to Iyer et al., U.S. Pat. No. 5,138,199 to Iyer et al., U.S. Pat. No. 5,310,582 to Vyakarnam et al., U.S. Pat. No. 5,660,923 to Bieler et al., and U.S. Pat. No. 5,891,249 to Bieler et al., each of which are hereby incorporated herein by reference in its entirety.

The graphite used herein comprises exfoliated graphite nanoplatelets. We have assumed there is a thin layer of nanographite on the glass fiber surface. Through calculation, the weight fraction of xGnP on the glass fiber can be obtained. If we assume that: (1) the glass fiber is very long (L>>D); (2) the glass fiber has a smooth outer surface; (3) the nano-graphite is homogenous with thickness (T) of fifteen nanometers (15 nm) and has a size of on micron (1 μm); and (4) that the monolayer xGnP coating is formed on the outer surface of glass fiber, then the weight fraction of mono layer xGnP on the glass fiber is given by Equation 1.

$${W}_{xGnP} \% = \frac{4 {T}_{xGnP} {ρ}_{xGnp}}{{D}_{glass} {ρ}_{glass}} . \qquad Equation 1$$

In Equation 1, WxGnP % is the weight fraction of xGnP on glass fiber surface, T_{xGnP} is the thickness of graphite nanoplatelets, ρ_{xGnP} is the density of graphite, D_{glass} is the diameter of glass fiber, and ρ_{glass} is the density of glass fiber. The densities of graphite and glass and diameter of glass fiber were 2.0 g/cm³, 2.5 g/cm³ and 20 μm, respectively. Thus, the theoretical weight fraction of monolayer xGnP coating on glass fiber is 0.2 wt %.

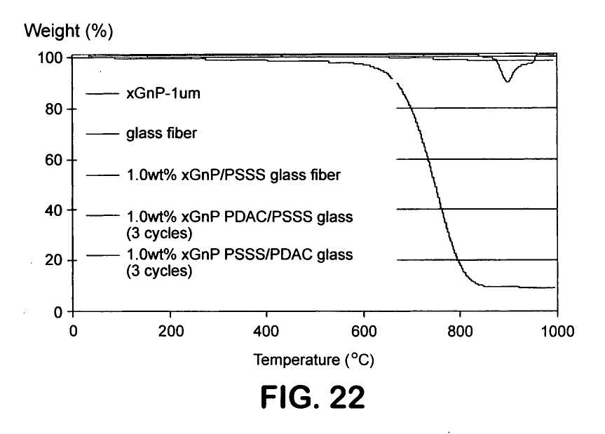

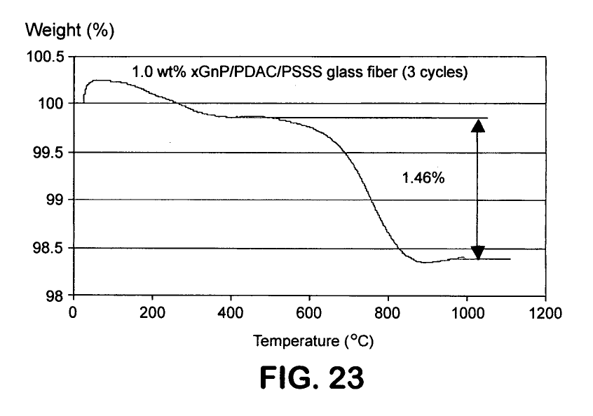

As a check, the weight percentage of xGnP on the glass fiber can be measured with a thermogravimetric analyzer (TGA). The thermogravimetric behavior of pure xGnP and xGnP coated glass fiber is shown in FIGS. 22 and 23. The pure xGnP starts to decompose around 600° C. and finishes around 860° C. under flowing air. By using this method, the single layer xGnP coating had a weight fraction of 0.16-0.23% on the glass fiber surface. The three cycle (six layer) xGnP coating had weight fraction of 1.5% on glass fiber surface (FIG. 23). This is consistent with the value of theoretical calculations, which indicates that the coating condition here used is really close to optimized condition.

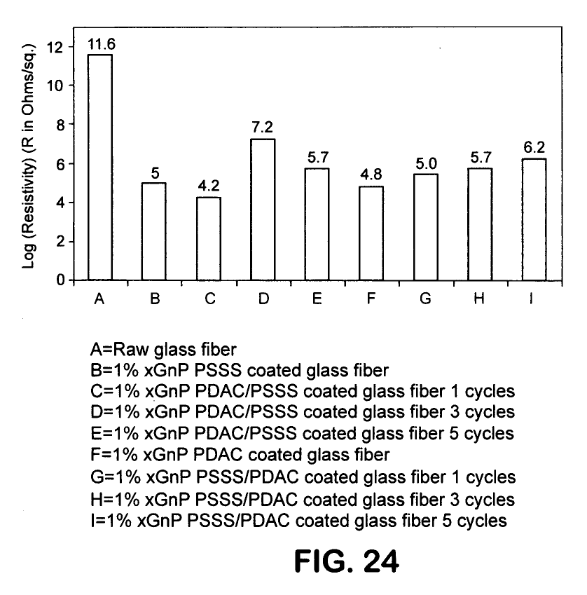

Comparing the resistivity of one layer and multiple layer coated glass fibers, as shown in FIG. 24, it appears that more than two layers coating is not helpful to produce reduced resistivity. A two layer coating is enough to get a highly conductive glass fiber. This may due to the fact that polyelectrolyte stays in between layers and hence blocks the movement of electrons from one layer xGnP to another layer of xGnP because the polyelectrolyte is not conductive. The role of polyelectrolyte is to interact with fiber through electrostatic interaction and penetrate to the xGnP to keep the xGnP solution stable. Use of a conductive polymer binder or film former can be used to improve the conductivity.

Based on the above results, the xGnP coating shows promising results in improving the conductive properties of the glass fibers. Glass fibers can be quickly and conveniently coated with conductive, exfoliated nanographite platelets (xGnP) through a variety of means described herein, so that the glass fibers exhibit acceptable levels of electrical conductivity. As a result of our work the following conclusions can be made. First, xGnP can be coated on the surface of glass fiber with a variety of methods and chemical processes, such as dipping the glass fiber into a water based suspension of a polyelectrolyte with xGnP, and spraying the water based suspension of a polyelectrolyte with xGnP. Second, the electrical resistance of the glass fiber was reduced to levels that made the graphite coated glass fiber conductive enough for electrostatic spraying, and this conductivity depends on the concentration of graphite and polyelectrolyte. Third, one layer coating is more effective and can result in better conductivity than multi-layer coating of xGnP. Fourth, the amount of coated graphite on the glass fibers with the best conductivity is only about 0.16 weight percent to about 0.2 weight percent (wt %).

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. A low resistivity graphite coated fiber comprising:
(a) an electrically insulating fiber having an outer surface; and
(b) exfoliated and pulverized graphite platelets having a particle size between about 0.1 and 500 microns coated on the outer surface of the electrically insulating fiber with a cationic or anionic polymer or mixtures thereof to provide the low resistivity graphite coated fiber.

2. The low resistivity graphite coated fiber of claim 1, wherein the electrically insulating fiber is a glass fiber.

3. The low resistivity graphite coated fiber of claim 2, wherein the weight fraction of exfoliated nanographite platelets on the outer surface of the glass fiber is from about 0.01 wt % to about 1.0 wt %.

4. The low resistivity graphite coated fiber of claim 1, wherein the electrically insulating fiber is a polymer fiber.

5. A reinforced composite material which comprises:
(a) a polymeric matrix; and
(b) a plurality of low resistivity graphite coated fibers mixed in the polymeric matrix, each of the low resistivity coated fibers comprising an electrically insulating fiber having an outer surface, and exfoliated and pulverized graphite platelets having a particle size between about 0.1 and 500 microns coated on the outer surface of the electrically insulating fiber with a cationic or anionic polymer or mixtures thereof, wherein the reinforced composite material enables electrostatic painting.

6. The reinforced composite material of claim 5, wherein the electrically insulating fiber is a glass fiber.

7. The reinforced composite material of claim 6, wherein the weight fraction of exfoliated nanographite platelets on the outer surface of the glass fiber is from about 0.01 wt % to about 1.0 wt %.

8. The reinforced composite material of claim 5, wherein the electrically insulating fiber is a polymer fiber.

9. The reinforced composite material of claim 5, wherein the polymeric matrix comprises a thermoset or thermoplastic polymer.

10. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns in a water based cationic or anionic polymer solution;
(c) coating the plurality of electrically insulating fibers with the graphite solution; and
(d) drying the sprayed fibers to provide the low resistivity graphite coated fibers.

11. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns in a water based cationic or anionic polymer solution;
(c) spraying the graphite solution onto the plurality of electrically insulating fibers for a time to provide sprayed fibers; and
(d) drying the sprayed fibers to provide the low resistivity graphite coated fibers.

12. The method of claim 11, wherein the graphite solution is 1 wt % of the exfoliated and pulverized graphite in water solution.

13. The method of claim 11, wherein the sprayed fibers are dried in step (d) at room temperature for more than twelve hours.

14. The method of claim 11, wherein the spraying time in step (c) is about ten seconds.

15. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns mixed in a water based anionic or cationic polymer solution;
(c) dipping the plurality of fibers into the graphite solution;
(d) dipping the fibers into water to remove excess graphite solution; and
(e) drying the sprayed fibers to provide the low resistivity graphite coated fibers.

16. The method of claim 15, wherein the graphite particles are ultrasonically mixed to provide the graphite solution in step (b).

17. The method of claim 15, wherein the fibers are as a bundle which is dipped into the graphite solution for about 1 to about 300 seconds.

18. The method of claim 15, wherein the graphite solution has a graphite concentration of 1 wt %.

19. The method of claim 15, wherein the fibers are dried in step (e) at room temperature.

20. A method of making a plurality of low resistivity graphite coated fibers comprising the steps of:
(a) providing a plurality of fibers;
(b) providing a first graphite solution comprising exfoliated and pulverized graphite particles mixed in a first water based cationic or anionic polymer solution;
(c) dipping the plurality of fibers into the first graphite solution;
(d) dipping the fibers into water to remove excess graphite solution;
(e) providing a second graphite solution comprising exfoliated and pulverized graphite particles mixed in a second water based cationic or anionic polymer solution which has a different cationic or anionic charge than the first graphite solution;
(f) dipping the fibers into the second graphite solution; and
(g) drying the sprayed fibers to provide the low resistivity graphite coated fibers.

21. The method of claim 20, wherein the first solution comprises a cationic polymer and the second solution comprises an anionic polymer.

22. The method of claim 20, wherein the first graphite solution comprises an anionic polymer and the second graphite solution comprises a cationic polymer.

23. The method of claim 20, wherein the exfoliated graphite particles are ultrasonically mixed into the water based anionic and cationic solutions to provide the graphite solutions in steps (b) and (e).

24. The method of claim 20, wherein glass fibers as a bundle are dipped into the water based graphite solution.

25. The method of claim 20, wherein the water based graphite solution has a graphite concentration of 1 wt %.

26. The method of claim 20, wherein the fibers are dipped into the cationic solution in step (c) for ten seconds.

27. The method of claim 20, wherein the fibers are dipped into the anionic solution in step (f) for ten seconds.

28. The method of claim 20, wherein the fibers are dried in step (g) at room temperature for more than twelve hours.

29. A method of electrostatic painting a reinforced composite material without using a conductive primer comprising the steps of:
(a) providing an electrically conductive reinforced composite material which comprises a polymeric matrix; and a plurality of low resistivity graphite coated fibers mixed in the polymeric matrix, each of the low resistivity coated fibers comprising an electrically insulating fiber having an outer surface; and exfoliated and pulverized graphite platelets having a particle size between about 0.1 and 500 microns coated on the outer surface of the electrically insulating fiber with a cationic or anionic polymer or mixtures therein to provide the low resistivity graphite coated fiber, wherein the reinforced composite material has sufficient conductivity to undergo electrostatic painting and to provide EMI and RF shielding;
(b) electrically grounding the reinforced composite material;
(c) providing a charged powder comprising a resin and a pigment;
(d) spraying the charged powder onto the electrically grounded reinforced composite material so as to coat the material; and
(e) curing the powder on the reinforced composite material in a curing oven, so as to electrostatically paint the reinforced composite material with the powder.

30. The method of claim 29, wherein the fiber is a glass fiber.

31. A low resistivity graphite coated fiber comprising:
(a) an electrically insulating fiber having an outer surface; and
(b) exfoliated and pulverized graphite platelets having a particle size between about 0.1 and 500 microns coated on the outer surface of the electrically insulating fiber to provide the low resistivity graphite coated fiber.

32. A reinforced composite material which comprises:
(a) a polymeric matrix; and
(b) a plurality of low resistivity graphite coated fibers mixed in the polymeric matrix, each of the low resistivity coated fibers comprising an electrically insulating fiber having an outer surface, and exfoliated and pulverized graphite platelets having a particle size between about 0.1 and 500 microns coated on the outer surface of the electrically insulating fiber, wherein the reinforced composite material enables electrostatic painting.

33. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns in a solution;
(c) coating the plurality of electrically insulating fibers with the graphite solution; and
(d) drying the sprayed fibers to provide the low resistivity graphite coated fibers.

34. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns in a solution;
(c) spraying the graphite solution onto the plurality of electrically insulating fibers for a time to provide sprayed fibers; and
(d) drying the sprayed fibers to provide the low resistivity graphite coated fibers.

35. A method of making a plurality of low resistivity graphite coated fibers comprising the steps of:
(a) providing a plurality of electrically insulating fibers;
(b) providing a graphite solution comprising exfoliated and pulverized graphite particles having a particle size between about 0.1 and 500 microns mixed in a solution;
(c) dipping the plurality of fibers into the graphite solution;
(d) dipping the fibers into water to remove excess graphite solution; and
(e) drying the sprayed fibers to provide the low resistivity graphite coated fibers.

36. A method of electrostatic painting a reinforced composite material without using a conductive primer comprising the steps of:
(a) providing an electrically conductive reinforced composite material which comprises a polymeric matrix; and a plurality of low resistivity graphite coated fibers mixed in the polymeric matrix, each of the low resistivity coated fibers comprising an electrically insulating fiber having an outer surface; and exfoliated and pulverized graphite platelets having a particle size between about 0.1 and 500 microns coated on the outer surface of the electrically insulating fiber to provide the low resistivity graphite coated fiber, wherein the reinforced composite material has sufficient conductivity to undergo electrostatic painting and to provide EMI and RF shielding;
(b) electrically grounding the reinforced composite material;
(c) providing a charged powder comprising a resin and a pigment;
(d) spraying the charged powder onto the electrically grounded reinforced composite material so as to coat the material; and
(e) curing the powder on the reinforced composite material in a curing oven, so as to electrostatically paint the reinforced composite material with the powder.
